(19) United States
(12) Patent Application Publication
(10) Pub. No.: US 2005/0060287 A1
(43) Pub. Date: Mar. 17, 2005

(54) System and method for automatic clustering, sub-clustering and cluster hierarchization of search results in cross-referenced databases using articulation nodes

(76) Inventors: Ziv Z. Hellman, Forest Hills, NY (US); Robert Todd Chesler, Hudson, NH (US)

Correspondence Address: Hoffman, Wasson & Gitler, P.C.;Crystal Center 2, Suite 522, 2461 South Clark Street, Arlington, VA, 22202, US

(21) Appl. No.: 10/845,097

(22) Filed: May 14, 2004

Related U.S. Application Data
(60) Provisional application No. 60/470,872, filed on May 16, 2003.

(51) Int. Cl. G06F 7/00

(52) U.S. Cl. 707/2

(57) ABSTRACT

Within the context of a cross-referenced data-base, an initial “base-set” of results to a query is generated using any conventional search engine tool. The base-set is then expanded by adding to it entries referencing entries in the original set or referenced by those entries, in a possibly iterative manner. The resulting collection of entries and references is represented as a mathematical graph or network, amendable to graph theoretic analysis. Connected components within the graph form top-level clusters, and articulation nodes within these clusters are calculated. These articulation nodes serve as both navigational “gateways” and anchors for sub-clusters. Sub-clusters, consisting of the transitive descendants of the articulation nodes, are associated with each articulation node. The articulation nodes themselves then form a graph, which is analyzed further for prominence, and a hierarchy of articulation nodes is calculated. The resulting hierarchy consisting of the top-level clusters and the sub-clusters associated with the articulation nodes is then presented visually to users in a manner enabling them to easily navigate through the space of expanded search results.

### CROSS-REFERENCED APPLICATIONS

This application claims the priority of U.S. provisional patent application Ser. No. 60/470,872, filed on May 16, 2003.

### FIELD OF THE INVENTION

This invention relates to the field of searching and navigating a large database of cross-referenced entries or documents.

The cross-referencing relations may be explicitly defined by the compilers of a data-base or inferred from textual or other references located within each entry or document. Examples of such internal references include, not exhaustively, citations as in legal or patent databases; bibliographic references as in academic papers; “see also” type references in collections of articles such as news compilations and encyclopedias; histories of purchases associated with particular consumers in collaborative-filtering data-bases; and hyper-links in hypermedia databases in networking environments, whether in Internets or Intranets.

More specifically, the invention relates to a system and method, using graph-theoretic structural analysis, for automatically generating clusters, sub-clusters and hierarchical views as navigational aids in response to user search queries in cross-referenced databases, enabling users to utilize a “divide-and-conquer” strategy to rapidly zero-in on search results most relevant to their needs.

### BACKGROUND OF THE INVENTION AND STATEMENTS OF PROBLEMS WITH THE PRIOR ART

The advent of extremely large electronic database collections of documents and articles—with the World Wide Web on the Internet the largest and most conspicuous example of such a database—has led to intensive efforts of formulating search tools enabling users to locate entries they are interested in by inputting queries and receiving in response groups of entries related to the inputted queries, with the search tools and their associated user interfaces going by the name of “search engines”.

In what follows, the term “documents” will frequently be used in place of “entries and documents”, with the implicit understanding that the relevant databases may contain any of various objects as entries, without necessarily being limited to textual documents.

Most such search engines operate according to one of a limited set of alternative models. Perhaps the most ubiquitous model is based on key-word searches—a small group of keywords is associated with each entry, and entries with associated keywords matching the inputted query are returned to users in a so-called “hit list”, generally ranked according to algorithms dependent on vector-based analysis and/or counting term frequency in each document. An extended version of this “syntactic comparison” search model compares the full text of each entry against the user query. Further sophistication can be added to the technique by combining keywords to form Boolean search strings (e.g. services such as Alta Vista.TM., Lycos.TM., and Infoseek.RTM. which operate on the World Wide Web).

More semantically-based approaches for organizing and retrieving information from databases employ statistical and matrix techniques in order to extract “latent semantic meanings” from documents (cf. U.S. Pat. No. 4,839,853, by Deerwester, et al.). Many of these techniques suffer from computational inefficiency.

A much commented-upon drawback of these search models, which have come to be referred to as “first-generation search engines”, is that in large databases the “flat” linearly-presented lists they generate can in contemporary data-bases typically contain thousands or even hundreds of thousands of individual entries, many of them not particularly relevant to the user's needs, which the user must wade through a handful at a time, leading many users frequently to give up in frustration. Adding more keywords in order to narrow the search, on the other hand, can over-constrain the results list so that it contains too few documents. The problems are magnified further in environments in which users are unfamiliar with the underlying database, or where the information content is continuously changing. In addition, studies indicate that most users of search engines do not want to type in long, specific Boolean queries.

A “second generation” of search engines has emerged attempting to alleviate this problem, with a number of different approaches proliferating. Most of the approaches recognize that the root of the difficulties inherent in the first-generation search engines rests with the inability of guessing a user's interests and intents based solely on query terms, due to the multiple references and meanings any given word may have. As examples, consider queries involving terms such as “mercury”, which may reference a planet, a make of automobile, a chemical element, a type of computer software, or a number of other meanings; or “Princeton”, which can refer to the university of that name, the New Jersey township, the printing press, a USS ship, or various corporations using the name.

In order to deal with this, one approach which has been tried essentially embeds a sophisticated electronic thesaurus in the search engine, with the user asked to select one of a set of terms semantically related to the query input in order to prune the base set of irrelevant entries (cf. www.oingo.com on the World Wide Web). While this approach has some merits, its effectiveness ultimately is limited by the linguistic and cultural understandings of the individual or group of individuals composing the “thesaurus”, and it has difficulty dealing with complex concepts as opposed to simple words and phrases. Given the almost infinite capacity of evolving human languages and cultures continually to invent new and different words, concepts and meanings, it is fair to say that this approach will always have built-in limitations to its applications.

Another approach relies on “document clustering”, presenting users with clusters of documents in order to enable them to select only the clusters which they find most relevant to their searching needs, thus significantly reducing the amount of information through which they must wade in the base set.

The simplest form of document clustering is manually generating categories and placing documents into each category by having a human being examining each document and placing the document into one of the categories. An example of this approach is used by YAHOO.TM. This method is very labor intensive and time consuming.

Amongst the most conspicuous of automatic document clustering techniques are the “Scatter-Gather” invention and the “Custom Folders” approach. Scatter-Gather (“Scatter/Gather: A Cluster Based Approach to Browsing Large Document Collections”, D. R. Cutting, D. R. Karger and J. O. Pederson, Proceedings of SIGIR '92—1992 and U.S. Pat. No. 6,038,557—Silverstein) and similar approaches prepare an initial off-line ordering of the corpus, and then on-line provide further ordering based on well-known clustering arts in response to iterative user selections, scattering and re-clustering results on each iteration. Based on a series of user selections, the invention then rearranges the ordered corpus in an attempt to further refine the presentation to the user. This approach requires a significant amount of user interaction in order to effectively prune search results, however. The Customs Folder approach (cf. U.S. Pat. No. 5,924,090—Krellenstein) makes extensive use of meta-data comparisons in order to organize base set entries into hierarchical categories. Both approaches are dependent on an off-line, pre-calculated hierarchy of categories—this again ultimately limits their applications because the a priori construction of a conceptual hierarchy of categories is itself a highly cultural and linguistic-bound endeavor, unable to capture a full range of evolving concepts and interrelations amongst concepts.

In order to avoid pre-assigned categories the use of a more natural and “inherent” structure in hypermedia databases has been suggested, based on the fact that hyper-linked entries may be viewed as forming a mathematical network or “graph”, having nodes which represent resources and arcs which represent embedded links between resources. The information content of this hyper-link structure itself may be profitably exploited in order to improve search technologies.

Some of the advantages of such an approach are clear and have been commented upon. A hyper-link between two entries reflects the fact that they share a relationship and therefore both of them are likely to be equally relevant or irrelevant to a user conducting a search. Considerations of links enables a search tool to provide hits which do not necessarily contain exact matches of query terms but are nevertheless relevant to the search at hand, e.g., an entry on differentiable manifolds may not contain the exact term “different topology” and will therefore be ignored by a pattern-matching search tool, even though its relevance to the search is high (this should be compared with the clustering and sub-clustering approach of U.S. Pat. No. 5,819,258, which uses features extracted solely form an initial document set without expanding to the documents which may be related but do not contain exact word matches to perform sub-clustering). Since users of hypermedia databases typically navigate through the space of database entries by following hyper-links, a local hyper-link structure contains in a sense a “snap-shot” of the entries a user is most likely to be interested in exploring. Finally, concentrating on links is a “language and culture-blind” act, because tools acting upon the hyper-link structure make no note of the language or content of the entries themselves, concentrating instead on the inter-relationships already inherent in the data-base by virtue of the links.

Most prior art exploitations of hyper-links structures, such as that in U.S. Pat. No. 5,920,859—Li, Page, L., PageRank: Bringing Order to the Web, Stanford digital Libraries Working Paper, 1997-0072, and Kleinberg, J. M., Authoritative Sources in a Hyperlinked Environment, Proceedings of the 9th Annual ACM-SIAM Symposium on discrete Algorithms 1998, p. 668, have concentrated on improving the rankings of search returns provided in the hits list, but the implementations based upon them have subsequently presented the hits list in a traditional flat linear manner, without hierarchical clustering, forcing users to continue to wade through long lists in a search for the most relevant results.

A related technique which makes use of links within the context of categories pre-determined by human editors (cf. U.S. Pat. No. 5,991,756—Wu) suffers from the same drawbacks mentioned above of missing potential sub-divisions and categories due to the linguistic and cultural limitations of any single committee of editors.

A few other attempts have been made at providing users with views of the “links neighborhoods” of relevant search results, containing not only the initial base set but also entries related to the initial list via hyper-links (cf. U.S. Pat. No. 5,875,446—Brown et al., U.S. Pat. No. 5,895,474—Maarek et al., and Bharat, K., Broder, A., Henzinger, M., Kumar, P., and Venkatasubramian, S. The Connectivity Server: Fast Access to Linkage Information on the Web, Proceedings of the 7th World Wide Web Conference, 1998, p. 469-477), and some clustering of the base set result as well. These inventions, however, essentially only display a basic tree of nodes based on the links connections and parent-child relations. Given that expanding an initial base set through following hyper-links can result in a multiplication of entries under consideration by an order of magnitude or more, the resulting tree of such interconnections may contain such a surfeit of edges and nodes as to be even more complex to comprehend and follow than the initial base set. Furthermore, these inventions single out “highly-ranked” nodes mainly by assuming that parent nodes are always the most important of navigational aids, and then ranking them according to the number of links emanating from them, which in and of itself is not always an indicator that said node is a “prominent” node for navigational purposes.

What is needed is a deeper exploitation of the information inherent in local hyper-linked structures, enabling a more refined division and separation of relevant clusters and sub-clusters of the nodes (representing entries) of the local hyper-linked structure, and resulting in a more sophisticated and revealing hierarchy than simple ancestor-child relations. Viewing cross-referenced databases as both directed and non-directed graphs is needed, because these different views present different types of relationships between entries, each of which is important in the right context. Furthermore, a more careful distillation of the key “gateway” nodes within the local hyper-linked structure and an exploitation of the links amongst them, in order to provide users with the most efficient navigational aids, is also needed. The structural analysis involved should be computable in real time with low complexity enabling users to obtain results within a reasonable time scale of submitting their queries. Finally, a simple user interface enabling users to easily navigate through the local hyper-link structure and rapidly select and store the set of entries most relevant to what they seek is needed as well. The user interface needs to provide orientation and a sense of knowing where one is in navigation and where one is going in a non-confusing manner computerized research tool.

It is the purpose of the current invention to answer these needs.

### SUMMARY OF THE INVENTION

A method and apparatus for clustering and sub-clustering of query responses within the context of a cross-referenced database, and furthermore defining a hierarchy of said clusters and sub-clusters, is disclosed. The present invention is premised on the idea that the presentation of a view of such a hierarchy of clusters and sub-clusters will enable users to more easily and rapidly zero-in on a set of highly relevant results than they could with the currently common presentation of a linear list of ranked results. It is further premised that articulation nodes, regarded as key “gateway” nodes in graphs, can serve as efficient navigational aids to users searching through cross-referenced databases.

The method of the present invention is generally comprised of the steps of: identifying entries topically relevant to a query using any generally known method to obtain an original set of topically relevant objects; expanding this list, by adding to it all entries which reference and/or are referenced by each and every entry in the original set, in iterative manner up to as many steps as may be determined either by default or by a user; calculating the “connected components” of a graph representation of said set and defining them to be top-level clusters; calculating the articulation nodes within each connected component; defining a sub-cluster associated with each of the articulation nodes by including within the sub-cluster the articulation node's transitive closure of descendants within the graph; calculating the prominence order of the articulation nodes; using that prominence order in order to create a hierarchy of clusters and sub-clusters in a breadth-first manner; presenting users, in a visual manner, the defined clusters and sub-cluster hierarchy, along with a “summary” or “name” for each such cluster and sub-cluster, in order to enable them to readily navigate amongst the clusters and sub-clusters; enabling users to store, in a persistent manner in computer memory, any of the said clusters and/or sub-clusters, and the visualization of their interconnections, as they should wish.

The process described herein can be performed on a number of apparatuses, and stored in memory on the computer system as a set of instructions. The set of instructions may also be stored on a computer-readable memory such as a disk, and the instructions can be transmitted from one computer to another over a network.

The language or languages in which the entries in the original database were written in play no role in the above methods, as it completely ignores the contents of the entries (after the initial topical base-set has been generated).

The foregoing description has been given for clearness of understanding only, and no unnecessary limitations should be understood therefrom, as modifications would be obvious to those skilled in the art.

### BRIEF DESCRIPTION OF THE DRAWINGS

These and other features, aspects and advantages of the invention are more fully understood from the descriptions and accompanying drawings below of preferred embodiments of the invention, which include:

FIG. 1 is a block diagram illustrating the functional elements of a search apparatus incorporating the principles of the invention;

FIG. 2, comprising FIGS. 2A, 2B and 2C, is a diagram of an example collection of search results and the local reference/links structure around it;

FIG. 3 is a diagram of an example Connectivity Index; and

FIG. 4 is a block diagram of the present invention.

### DETAILED DESCRIPTION OF THE PREFERRED EMBODIMENTS

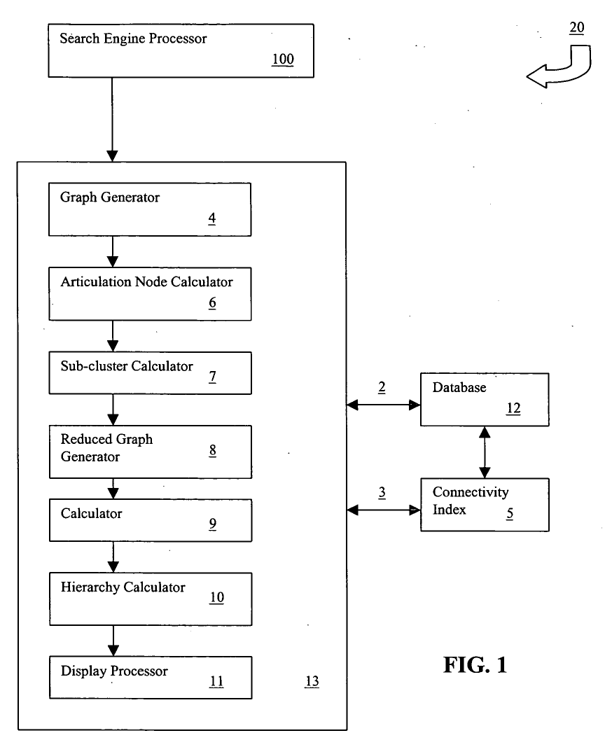

FIG. 1 is a block diagram illustrating the functional elements of a search apparatus incorporating the principles of the invention. The apparatus 20 includes a search engine processor 100 and a clustering/sub-clustering/hierarchization processor 13. The latter processor comprises a local reference/links graph generator 4, a connected component and articulation node calculator 6, a sub-cluster calculator 7, a reduced graph generator 8, an ordering by prominence calculator 9, a hierarchy calculator 10, and a display processor 11. These elements are software modules and have been so identified merely to illustrate the functionality of the invention. The apparatus 20 communicates with a user and a database 12 along with a pre-compiled connectivity index 5, via I/O buses 2 and 3. The apparatus 20 is capable of communicating with a plurality of remotely located users over a wide area network (e.g. the Internet).

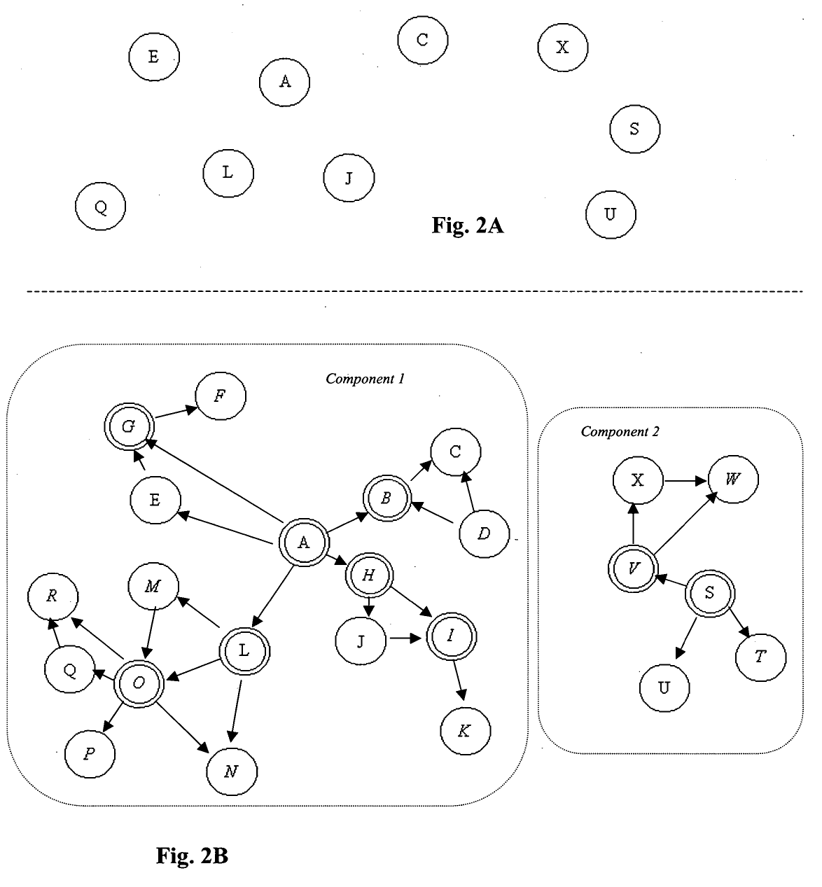

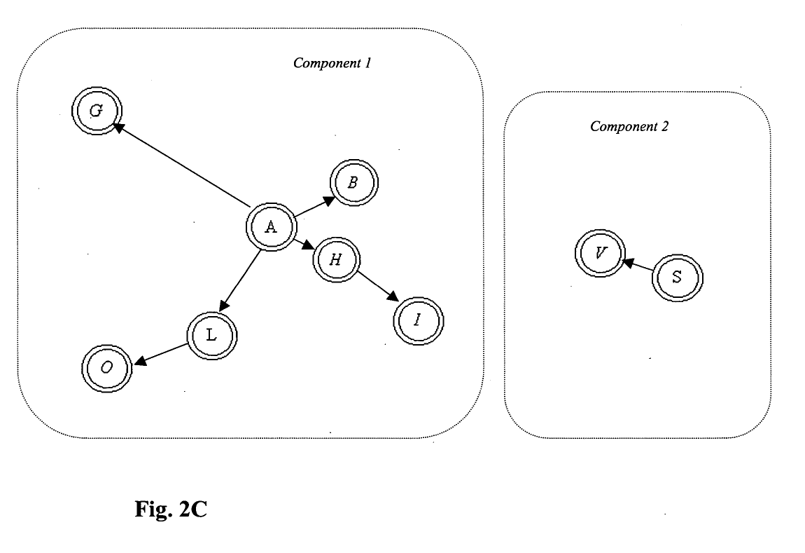

FIG. 2 gives an intuitive description of the current invention. The current invention operates on a cross-referenced data-base, which consists of entries and directed relationships between those entries. FIG. 2 is a block diagram of an example collection of objects in such a cross-referenced data-base. FIG. 2A shows a representative example of objects from such a data-base returned by a topical search engine in response to a user query. The topical search engine would typically present objects A, E, C, Q, L, J, X, S, V as a linear original or “base-set”, ranked according to some internal algorithm used by the search engine 100.

FIG. 2B shows the local references/links structure graph generated from the original base-set. Every object in FIG. 2B is at most “two hops” away from the elements of the base-set, each hop here referring to a reference-to or referenced-by relationship as depicted by the arrows between the objects.

Having constructed the local references/links structure graph, the invention proceeds to cluster the elements of that graph according to connected components, regarding the graph as being non-directed. In this example, elements A, B, C, D, E, F, G, H, I, J, K, L, M, N, O, P, Q, and R comprise one connected component (because a path may be drawn from each one of these elements to another one in the same list, labeled here Component 1. Similarly, elements S, T, U, V, W, and X form a separate and disjoint connected component, labeled here Component 2. Each of these components is defined to be a “top-level” cluster, and is given a name or label.

The invention then calculates the articulation nodes in each cluster. Nodes are considered articulation nodes if their removal from the graph would cause a formerly connected component to become disconnected. In this example, the articulation nodes in Component 1 are elements A, G, B, H, I, L and O, and are identified by double circles. The articulation nodes in Component 2 are S and V, and are similarly identified.

The articulation nodes are used to define sub-clusters. According to one preferred embodiment, in this example the following sub-clusters would be associated with each articulation node:

A: A, B, H, E, G, L.
G: G, F.
B: B, C, D.
H: H, J, I.
I: I, K.
L: L, M, N, O.
O: O, R, Q, P.
S: S, T, U, V.
V: V, X, W.

A “reduced directed graph” whose nodes are the articulation nodes and whose arcs are determined between the nodes based on a transitive ancestor/descendant relationship, is generated. The reduced graph in this example is depicted in FIG. 2C. As the reduced graph makes clear, there is a structural relationship thus defined between the articulation nodes. Some articulation nodes are “further downstream” than their ancestor articulation nodes. In order to determine the order of articulation nodes, a prominence calculation is executed, based on similar algorithms used in social network theory (cf. Wasserman, S. & Faust, K., Social Network Analysis, 1994, Cambridge University Press). The algorithm creates an incidence matrix capturing the relationships between the articulation nodes in the reduced graph, and calculated the eigenvectors of the matrix. The entries in the principal eigenvector (i.e. the eigenvector of greatest absolute Euclidean length), ordered by decreasing size, reflect the order of prominence. In this example, in Component 1, A is more prominent than all the other articulation nodes, L is more prominent than O, and H is more prominent than I. In Component 2, S is more prominent than V.

The prominence order is then exploited to produce a hierarchy of articulation nodes in each connected component. In this example, the hierarchy thus produced is as follows: For Component 1: first level: A, above B, G, L and H. Second level: G, B, L above O, and H above I. Third level: O and I. For Component 2: First level S, above V. Second level: V.

Finally, the sub-clusters associated with each articulation node (or their associated names and/or labels) are presented to the user in either hyper text markup language (HTML) form or a three-dimensional virtual reality makeup language (VRML) display.

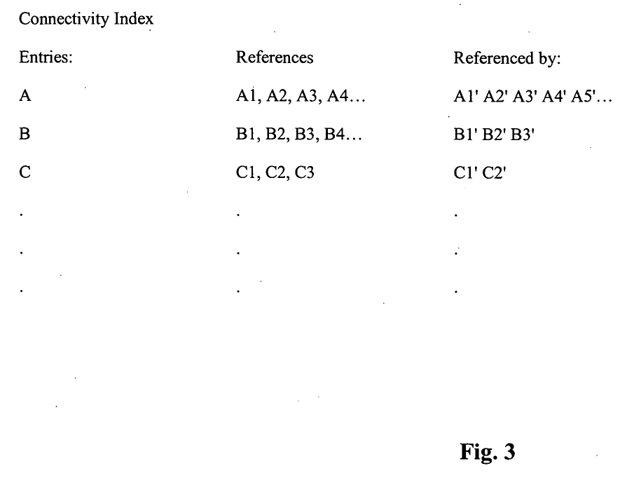

FIG. 3 is an example of a Connectivity Index, compiled from a cross-referenced data-base. Given an entry in the “entry field”, the references in that entry are listed in an associated field, and the entries referencing that entry are listed in another associated field. These associated fields are compiled for each and every entry.

The technique of the present invention uses mathematical graph theory and 3-D visualization techniques to provide a natural new way to conduct web searches or searches of any other cross-referential large data sets. The purpose of the invention is to present search results data in natural hierarchical order based on the mathematical relationships of web page linkage or other data object attributes.

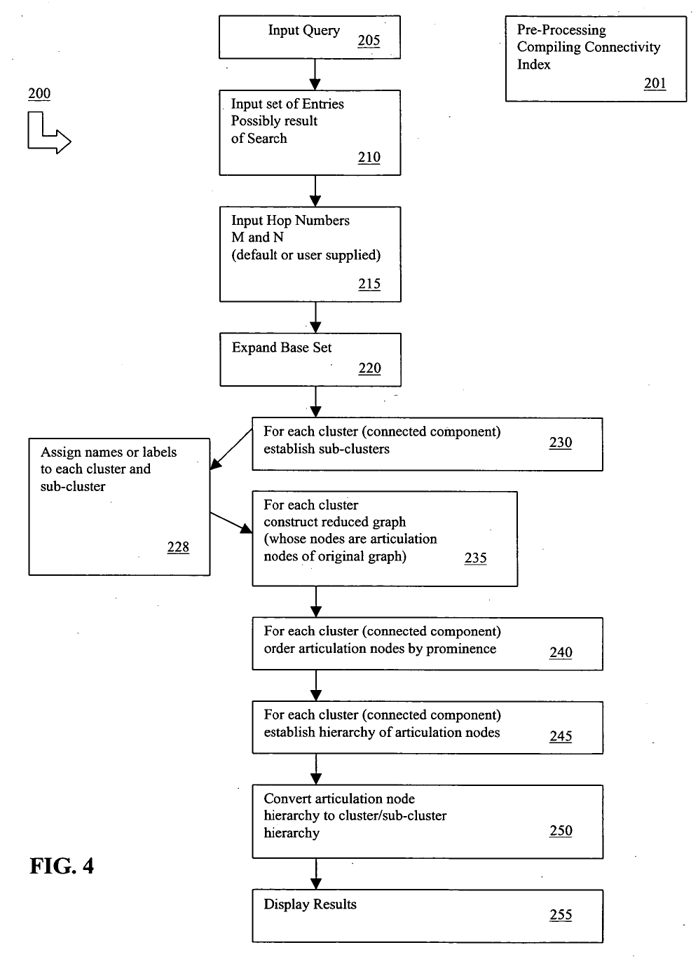

Referring to FIG. 4, the present invention will now be explained with respect to this flow chart 200. Initially, a connectivity index as illustrated in FIG. 3 would be compiled from a cross-referenced database. Entries, entered by a user would each be associated with an associated field. These associated fields are compiled for each and every entry at step 201. The user would then, utilizing a suitable search engine, input a query at step 205. This input would include one or more entries. Based upon the entries entered by the use at step 205, the search engine at step 210 would search for these entries for the purpose of producing a result. It is noted that these entries would result in an original base-set. As shown in FIG. 2B, since every object is at most “two hops” away from the elements of the base-set, it is important for the user to input the number of “hops” utilized to construct the local references/links structure graph. Although FIG. 2b shows the use of “two hops”, the number of hops would be entered by the user at step 215 or would be defaulted to a set number of hops, such as two. Based upon the input at step 215, the present invention would expand the database at step 220.

Based upon the expanded base-set at step 220, the system according to the present invention utilizing the articulation node calculator 6 shown in FIG. 1, connected components and articulation nodes would be calculated at step 225.

At this point, for each cluster (connected components) and sub-clusters are established at step 230 employing the sub-cluster calculator 7. Names or labels to each of the clusters and sub-clusters would be assigned in step 228. Thereafter, for each cluster construct, the reduced graph generator 8 would construct the reduced graph at step 235. Utilizing the ordering by prominence calculator 9 for each cluster, the articulation nodes would be ordered in decreasing size at step 240. Subsequently, at step 245, a hierarchy of the articulation nodes would be calculated using the hierarchy calculator 10 shown in FIG. 1. At this point, the articulation node hierarchy to cluster/sub-cluster hierarchy would be converted at step 250. Finally, the results would be displayed at step 255 utilizing the display processor 11. This display would be presented to the user in either HTML form or a three-dimensional display. The three-dimensional display could utilize various types of implementation such as VRML or Java-3D, as well as other three-dimensional techniques.

The invention includes several components.

One of the most significant components in the sub-clustering analysis of a graph using proprietary analysis methods according to the present invention.

Another significant component is the manner in which the result is organized so that it can be visualized, allowing the search domain to be intuitively understood by the user.

Yet another significant component is the manner configuring the processing steps to take advantage of distributed processing techniques and the processing power of the user's desktop.

A unique aspect of the present design is the inclusion of an annotable work product for subsequent further searches within the same domain, and anticipating the serious detailed drilling down of search results as users refine their search target or wish to provide an exhaustively thorough breadth of search according to manner of effectively classifying and ordering the search results.

The processing algorithm is integrated into the user's web browser, using persistent objects to effect an object database representing harvested data from the web or other raw data set. This results in a transferable work product to other users interested in the same search domain.

The processing steps according to the present invention include harvesting a base set of nodes to seed the harvesting of data using for example a ubiquitous back end search engine, as well as allowing a user to directly enter a base set of nodes. In this fashion the present invention is a meta search engine that implements inventive proprietary data organization and visualization that is so revolutionary in the way users will conduct web searches that it is disruptive to the web search business.

As a centralized meta search implementation detailed analysis is performed on base search results of a ubiquitous back-end search engine to present data in a meaningful hierarchical order. A traditional appearance is maintained with a textual result in a more effective order based on our analysis. A parallel 3-D graphical visualization view to the user through one of two mechanisms is also presented. Either the user receives two separate result sets, one textual and one graphical, or the user receives a graph representation with all the data necessary to generate both result sets in parallel directly within the user's web browser's cooperative processes or integrated plugged in enhancements.

As a de-centralized desktop tool implementation no central web server is required, which could be a bottleneck to serving the needs of multiple users simultaneously. This inventive approach capitalized on the built-in web browser search support with a cooperating process plugged in to the browser which triggers upon the sidebar search results model to activate our analysis software.

The analysis is also applied to several business process functions in various domains including a banner advertisement prospecting tool or various domains including a banner advertisement prospecting tool or competitive analysis tool, to traditional search engine placement by ranking improvements, to inferring keywords for search engines that use such information. The analysis is also applied to other forms of analysis such as detecting email user's digital signatures patterns of use, or discovering social-networking rings such as terrorists hiding behind disposable anonymous email addresses.

The visualization model is inventive in that it avoids many of the traps that other analysis systems have fallen into, such as displaying too much linkage information rather than just conveying a hierarchical structure of sets of nodes in equivalent rank, where rank has nothing to do with original order of a major search engine and everything to do with the social order of how data objects link to each other. The top-level web search clusters are visualized as a set of equivalent rank cluster member base set nodes which orbit the most prominent member of the set. The sub-clusters are visualized through establishing a hierarchical organization within the cluster based on a prominence ranking of articulation. A sub-cluster's elements orbit the articulation node which is most prominent within that sub-cluster's set of nodes.

As described by the present invention, the invention would utilize a base set acquisition method which can be configured by direct entry of URLs, or to harvest the base set from any of a number of publicly accessible search engines. It is important to note that the type of search engine utilized by the present invention is immaterial to creating the outputs envisioned by the present invention.

The present invention would utilize a persistent data storage system which harvests and stores attributes from each base set or other URL node of interest which can then be configured to use a relational database system or a persistent object system. With respect to the persistent data storage system, as a “crawled” database is built within the union of all of the user's search domains of interest, further searches in similar domains would become more efficient and require less data harvesting. The persistent objects would “model” the relationship between web pages in an object-oriented fashion and to also set up appropriate “network” data structures that officially brings the crawl cache down to a desktop implementation.

The search domain could be drilled-down into and examined in logical cluster-base order by various individuals making annotations and adding to the working document by further searches in similar domains. These multiple users could divide and conquer a search space by clusters in a manner to insure that collaborating workers are traversing the search domain space without much overlap. Although it need not be limited to an XML file, this type of file would be able to export the subset of the crawl-cache to the XML file in a manner to share the files across desktop systems since there is a known problem of “concurrent merge” with synchronizing databases. Furthermore, the export of a subset of a crawl-cache is precisely analogous to the data that must be transmitted from the central meta-search web server to a plug-in web browser utilized by the present invention when running in that mode for distributed processing.

The present invention utilizes distributed processing to produce the correct graphical outputs. Rather than computing the visualization and textual cluster-order representation on the meta-search web server, the crawl is run on the web server of the present invention and the graph results are sent in a format to feed the plug-in of the graph of only what is relevant to produce the HTML, VRML as well as other displays. The distributed processing is accomplished to minimize the data being transferred between in the case of HTML and VRML displays overlap between these displays to endeavor to minimize the transmission of overlapping data in both of the formats.

The three-dimensional visualization system, according to the present invention, methodically conveys a representation of the mathematical graph analysis calculations which can then be manipulated via standard three-dimensional viewer software mechanism to permit an individual to intuitively become familiar with their search domain allowing the individual to perceive their abstract space through the human visual system and natural processing method in an unexpected manner.

The present invention provides a textual representation of the search results which facilitates a clusterized view of the base set nodes analyzed as well as certain interesting URL nodes found during the analysis calculations, such as articulation nodes that were not in the base set. The present invention accepts base-set increments such as when being fed a portion of the base set nodes at a time through traditional search engines. This would involve the incremental display of changes in the clusterized view by highlighting new clusters, modified clusters and clusters which do not change from the previously visualized pre-incremented base set. Furthermore, the present invention would produce the textual and graphical clusterized view as a meta-search engine using harvested data from prior analyses in subsequent analyses.

The present invention would utilize as a combination of local desktop processing, a web browser plug-in for the computational-intensive task of graph analysis, clusterization and visualization generation by using the central meta-search engine web server as a reusable database cache of prior graph data. The web browser plug-in would include a built-in sidebar search tab with a local reusable persistent object data store for the harvested URL data with simultaneous and multi-threaded capability for multiple parallel searches in multiple main browser windows, and with simultaneous harvesting and analysis operations as well as simultaneous textual and graphical view generation.

The present invention can apply the aforementioned technologies into viable business processes such as traffic analysis for banner advertisement placement or search engine submission utilizing the search technique of the present invention to visualize where a web space is appropriate areas for efficient marketing, and to track a competitors advertisement placement strategy. Furthermore, the present invention can be used for other cross-referenced data spaces such as electronic mail, treating message recipients as linkage data and e-mail addresses as URL's and developing an e-mail analysis system which can be used with only public message header data, such as stored on a central ISB mail server or on a central ISP mail server log, for various purposes including recognizing digital signature patterns of anonymous email users and determining communities of socially-networking users, with particular attention to be placed upon email messages with problematic message bodies from a homeland security standpoint so that the graph analysis can detect certain subject matters.

The foregoing is considered as an illustration only of the principals of the present invention. Numerous modifications and changes will readily occur to those skilled in the art. It is not desired to limit the invention to the exact construction and operation shown and described, accordingly all modifications and equivalents thereof may be used and still fall within the scope of the claimed invention.

1. A method for clustering and sub-clustering documents and/or other types of objects listed as entries in a cross-referenced database or plurality of databases, along with a hierarchization of the resultant clusters and sub-clusters, the method comprising the steps of:
a) entering one or more first entries in the database, said first entries referred to as an original base set;
b) determining in the database second entries which reference to each of said first entries;
c) calculating a link number defined as the number of second entries referencing each of said first entries;
d) utilizing a connectivity index produced by a cross-referenced database for each of said first entries to create an augmented base set of said first entries;
e) expanding said augmented base set by adding to it all entries which reference and/or are referenced by each and every entry in said original base set;
f) iteratively repeating step e), in either a forward direction or a backward direction;
g) defining clusters and sub-clusters of the expanded set of entries;
h) creating a hierarchy of the said clusters and said sub-clusters;
i) presenting users, in a visual manner, the defined clusters and sub-cluster hierarchy; and
j) enabling users to store, in a persistent manner in a computer memory, any of the said clusters and/or said sub-clusters, and the visualization of their interconnections.

2. The method in accordance with claim 1, further including the step of providing the users with a summary or name for each of said clusters and sub-clusters, allowing the user to navigate between said clusters at and said sub-clusters.

3. The method for generating the clusters and sub-clusters, in accordance with claim 1, including the steps of:
a) representing said expanded set of entries as a mathematical non-directed graph or network within the computer memory;
b) calculating the connected components of said graph;
c) calculating within each of said connected components, articulation nodes bridging each of said connected components;
d) defining each connected pairs of connected components so calculated as a basic cluster of entries;
e) associating with each of said articulation nodes its respective set of transitive descendants, said set of transitive descendants being defined as a basic sub-cluster of the cluster of which said articulation node is a member;
f) assigning a name to each of said clusters and said sub-clusters by making use of a weighted averaging formula summarizing keywords, titles, and/or other textual elements associated with each entry within said clusters or said sub-cluster;
g) creating a representation of a reduced mathematical directed graph, said articulation nodes and directed arcs defined between said nodes defined whenever one articulation node is a transitive ancestor of another articulation node;
h) calculating the relative prominence of said articulation nodes associated with each said connected components, utilizing eigenvectors of incidence matrices;
i) traversing said reduced graphs beginning with the most prominent articulation nodes in each connected component;
j) translating the hierarchy of said articulation nodes in each of said connected components, using the association of a sub-cluster to each of said articulation nodes; and
k) presenting the full hierarchy of said clusters and said sub-clusters to the users.

4. The method in accordance with claim 3, further including the step of presenting a visual display to the users in hyper text markup language.

5. The method in accordance with claim 3, further including the step of presenting a three-dimensional visual display to the users in three dimensional virtual reality markup language.

6. The method in accordance with claim 5, wherein the step of presenting said three-dimensional display is accomplished using virtual realize markup language.

7. The method in accordance with claim 7, wherein said augmented base set is a set of web pages.

9. The method in accordance with claim 1, further including the step of utilizing a browser plug-in for clustering and sub-clustering the documents.

10. The method in accordance with claim 3, further including the step of utilizing a browser plug-in for clustering and sub-clustering the documents.

11. The method in accordance with claim 1, further including the steps of:
maintaining said clusters and sub-clusters in a memory; and
utilizing said clusters and said sub-clusters in said memory as a domain to be used in searches of similar documents.

12. The method in accordance with claim 3, further including the steps of:
maintaining said clusters and sub-clusters in a memory; and
utilizing said clusters and said sub-clusters in said memory as a domain to be used in searches of similar documents.

13. A system for clustering and sub-clustering documents and/or other types of objects listed as entries in a cross-referenced database, comprising:
a device for entering search entries in a search engine processor;
a device for calculating links between said search entries;
a device for mathematically representing an expanding set of said entries as a non-directed graph;
a device for calculating connection compounds of said graph;
a device for calculating articulation nodes bridging each of said connected components;
a device for defining transitive descendants of said articulation nodes, defined as a basic sub-cluster;
a device for creating a reduced mathematical directed graph utilizing said non-directed graph and said articulation nodes;
a prominence calculator used to order each of said articulation nodes in decreasing size based upon said connected components; and
a display device of displaying the output of said search entries.

14. The system in accordance with claim 13, wherein said display device displays a three-dimensional rendition of said sub-classes and said articulated nodes.

15. The system in accordance with claim 13, further including a hierarchy calculator for calculating the hierarchy of said articulation nodes.

16. The system in accordance with claim 14, further including a hierarchy calculator for calculating the hierarchy of said articulation nodes.
